(19) United States
(12) Patent Application Publication
(10) Pub. No.: US 2016/0044282 A1
(43) Pub. Date: Feb. 11, 2016

(54) DESK-SIDE SURVEILLANCE

(71) Applicant: Polycom, Inc., San Jose, CA (US)

(72) Inventor: Subburaja Veluchamy, Hyderabad (IN)

(21) Appl. No.: 14/818,074

(22) Filed: Aug. 4, 2015

(30) Foreign Application Priority Data
Aug. 5, 2014 (IN) 3834/CHE/2014

(51) Int. Cl. H04N 7/18; H04N 7/14; H04N 5/232; H04N 5/33

(52) U.S. Cl. CPC H04N 7/181; H04N 5/33; H04N 7/142; H04N 7/147; H04N 5/23296

(57) ABSTRACT

A surveillance system incorporates desktop videophone devices to monitor workspaces in an office environment. Desktop videophones include a camera system and a network interface for transmitting image data from the camera system to a receiver, which may be configured to transmit image data from the camera to a surveillance monitoring system. Videophones are often located at office workspaces within cubes, offices, and conference rooms where walls and partitions may obstruct the view of surveillance cameras installed in open or general-use areas, such as lobbies and hallways. As such, employing desktop videophones in a surveillance capacity expands monitoring to workspaces without requiring installation of additional surveillance cameras for individual workspaces.

### CROSS-REFERENCE TO RELATED APPLICATIONS

This Application claims priority to India Utility Application No. 3834/CHE/2014 entitled “Desk-Side Surveillance” filed Aug. 5, 2014, which is incorporated by reference in its entirety herein.

### FIELD OF THE INVENTION

The present disclosure relates generally to surveillance systems and, more particularly, to employing a desktop videophone as part of a surveillance system.

### BACKGROUND

Surveillance systems may be used to monitor areas for a wide variety of security purposes, including safety, anti-theft, and confidentiality. Surveillance systems may consist of a network of cameras controlled by a central monitoring system. Surveillance cameras are typically placed in offices, warehouses, building, or the like and are oriented to monitor areas critical to security. These areas include, for example, entry doors, high traffic areas, and high security areas. A central monitoring system may aggregate image and video streams for the network of surveillance cameras, enabling live viewing or storage for later viewing and analysis.

Open areas require fewer surveillance cameras, as each camera may be used to cover an area corresponding to its viewing capabilities. Areas having a larger number of walls and partitions, such as traditional office environments, make it difficult to efficiently use surveillance cameras, as walls and partitions limit each camera's view. As such, spaces having lots of walls, partitions and hallways may only be monitored in certain areas to avoid the expense of installing cameras in every enclosed or partially-enclosed area. Therefore, it would be desirable to provide a surveillance system capable of monitoring individual offices, cubicles and workspaces without requiring installation of additional surveillance cameras.

### SUMMARY

A surveillance system incorporating desktop videophone devices is disclosed. Desktop videophones include a camera system and a network interface for transmitting image data from the camera system to a receiver, which may be configured to transmit image data from the camera to a surveillance monitoring system. Videophones may be located at office workspaces within cubes, offices, and conference rooms where walls and partitions may obstruct the view of surveillance cameras installed in open or general-use areas, such as lobbies and hallways. As such, in one aspect, employing desktop videophones in a surveillance capacity expands monitoring to workspaces without requiring installation of additional surveillance cameras for individual workspaces. In another aspect, the additional data and network bandwidth required to handle the increase in image data associated with an increased number of cameras may be controlled by analyzing, processing, or compressing image data locally on the desktop videophone prior to transmission to a central surveillance monitoring system.

### BRIEF DESCRIPTION OF THE DRAWINGS

FIG. 1 illustrates a top-down view of a surveillance network including surveillance cameras and desktop videophones, according to an embodiment of the invention.

FIG. 2 illustrates a top-down view of the surveillance area of desktop videophones within partially-enclosed workspaces, according to an embodiment of the invention.

FIG. 3 illustrates a surveillance system including desktop videophones, according to an embodiment of the invention.

FIG. 4 illustrates a method for processing image data generated by a desktop videophone for surveillance purposes, according to an embodiment of the invention.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

A surveillance system incorporating desktop videophone devices is disclosed. The desktop videophone device includes a camera system and a network interface for transmitting image data from the camera system to a receiver. In an embodiment, the receiver may be configured to transmit image data from the camera to a surveillance monitoring system. Videophones are often located at office workspaces within cubes, offices, and conference rooms where walls and partitions may obstruct the view of surveillance cameras installed in open or general-use areas, such as lobbies and hallways. As such, employing desktop videophones in a surveillance capacity expands monitoring to workspaces without requiring installation of additional surveillance cameras for individual workspaces.

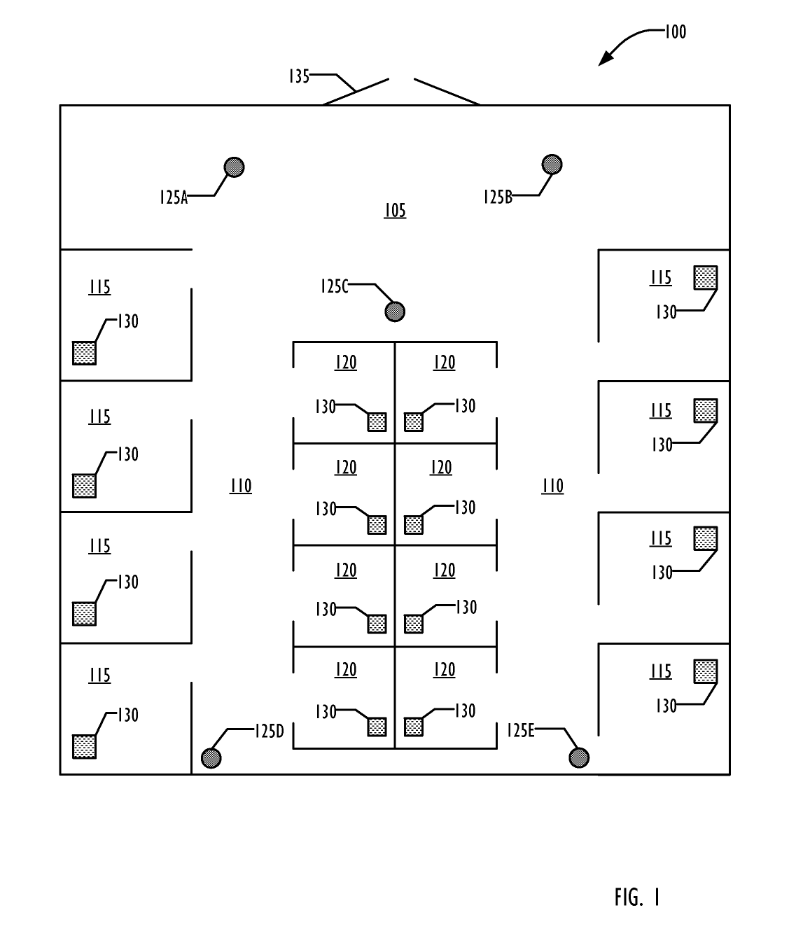

Referring to the figures, FIG. 1 illustrates an office environment 100 monitored by a surveillance network including desktop videophones 130, according to an embodiment of the invention. Office 100 includes an entryway/lobby 105, hallways 110, offices 115 and cubicles 120. Offices 115 may be enclosed rooms having full, floor-to-ceiling walls. Cubicles 120 are defined by partitions that extend only partially to the ceiling. Each of offices 115 and cubicles 120 include separate workspaces, each having a desktop videophone 130. The surveillance network may also include surveillance cameras 125A, 125B, 125C, 125D and 125E that are positioned within office environment 100.

Surveillance cameras 125A-125E may be any suitable type of closed-circuit camera, such as dome or bullet-type cameras. Surveillance cameras 125A-125E may be mounted in any suitable way, such as on a wall or suspended from the ceiling. In embodiments, surveillance cameras 125A-125E may be fixed cameras, may be manually panned and tilted, or may be fully pan-tilt-zoom (PTZ) controlled as is conventional so as to capture images from a field of view of each camera from within office environment. Typically, surveillance cameras 125A-125E generate a video or image stream, which may be communicated to a central monitoring system or station (not shown) for viewing, storage, and analysis. In an embodiment, each surveillance camera 125A-125E may also include an audio capture device such as, for example a microphone that may be used for capturing audio within office environment 100. Captured audio may be subsequently transmitted to the central monitoring system or station (not shown) for processing. Analysis of image and audio data may be performed by a user of the central monitoring system or station or by software.

Surveillance cameras 125A-125C may monitor entryway 105, according to an embodiment of the invention. Entryway 105 is a large open area with few obstructions. Surveillance cameras 125A-125B may be oriented to have unobstructed views of both entryway 105 and hallways 110, according to an embodiment. Surveillance camera 125C is oriented to have an unobstructed view of entry 135, according to an embodiment. Surveillance cameras 125D-125E are located and oriented to have unobstructed views of hallways 110. Due to the lack of obstructions, surveillance cameras 125A-125E can monitor the entryway 105 and hallways 110.

However, the view of surveillance cameras 125A-125C into offices 115 may be fully obstructed by the walls defining each office 115. In addition, the view of surveillance cameras 125A-125C into cubicles 120 may be at least partially obstructed by the partitions defining each cubicle 120. Monitoring the workspaces and areas within each office 115 and cubicle 120 requires additional cameras located within the walls defining each office 115 or cubicle 120.

A desktop videophone 130 is located within each office 115 and cubicle 120 for both videoconferencing and monitoring the workspaces and areas within the respective offices and cubicles, according to an embodiment of the invention. In an embodiment, each desktop videophone 130 may include a camera system that can enable both videoconferencing and monitoring of workspaces and areas within each office 115. The camera system may be a fixed camera, may be a manually panned and tilted camera, or may be a fully PTZ controlled camera, all hereinafter referred to as “camera” for simplicity of this description, in order to capture video images from within the walls of the office 115 or cubicle 120. An example of a manually tilt and pan camera system is the POLYCOM® VVX® series phone. By virtue of being located within the walls of an office 115 or cubicle 120, each desktop videophone's 130 camera can view substantial portions of the office environment 100 since there are no walls or partitions blocking the camera's view of the office 115 or cubicle 120 within which it is located. Thus, the camera may have advantages over the views obtained from surveillance cameras 125A-125C, which are located outside offices 115 and cubicles 120. In another embodiment, each desktop videophone 130, by being selectively controllable to pan and tilt, can increase each camera's view of substantial portions of the office 115 and cubicle 120. In an embodiment, each camera may include infrared night vision for capturing infrared images within a dark environment or at night. Each desktop videophone 130 may also be configured to capture audio within each office 115 or cubicle 120 from a built-in microphone of the camera or, alternatively, from a microphone connected to the desktop videophone 130. For example, audio may be used to detect and/or locate intruders within each office 115 or cubicle 120. In an embodiment, audio enhancement and recognition may be used to trigger audio generation from each camera, such as, detecting sounds like breaking glass, voice detection such as audible voice stress or cries for assistance, or the like.

As used herein, workspace indicates a desk, table, or station corresponding to a desktop videophone 130. A single room—an office, conference room, cubicle, etc.—may include multiple workspaces. A workspace may be assigned to an individual, and may include other equipment associated with that individual, such as a computer or a filing cabinet. Because a desktop videophone is positioned within/adjacent to the workspace, it has a vantage point from which the camera may observe the corresponding workspace while the microphone may capture audio of the same workspace. As such, in addition to providing surveillance from within office walls, a desktop videophone with its camera may provide a view of the individual workspace using as environmental cues to monitor activity around the workspace, for example, sounds and movement around the workspace. The workspace vantage point may enable monitoring activity around the workspace. For example, the desktop videophone 130 may enable monitoring of individuals who access a computer or a filing cabinet or use the videophone 130, monitoring for smoke or water damage to the workspace, identifying security personnel as they walk in and out of cubicles 130 so as to monitor their behavior through the cubicles 130, or monitoring for other workspace-related activities of security concern.

Together, the network of desktop videophones 130 within office environment 100 enable surveillance monitoring within offices 130 and cubicles 120 without requiring additional surveillance cameras such as, for example, without requiring surveillance camera 125A, 125B or 125C to be installed within each office 115 or cubicle 120, according to an embodiment of the invention.

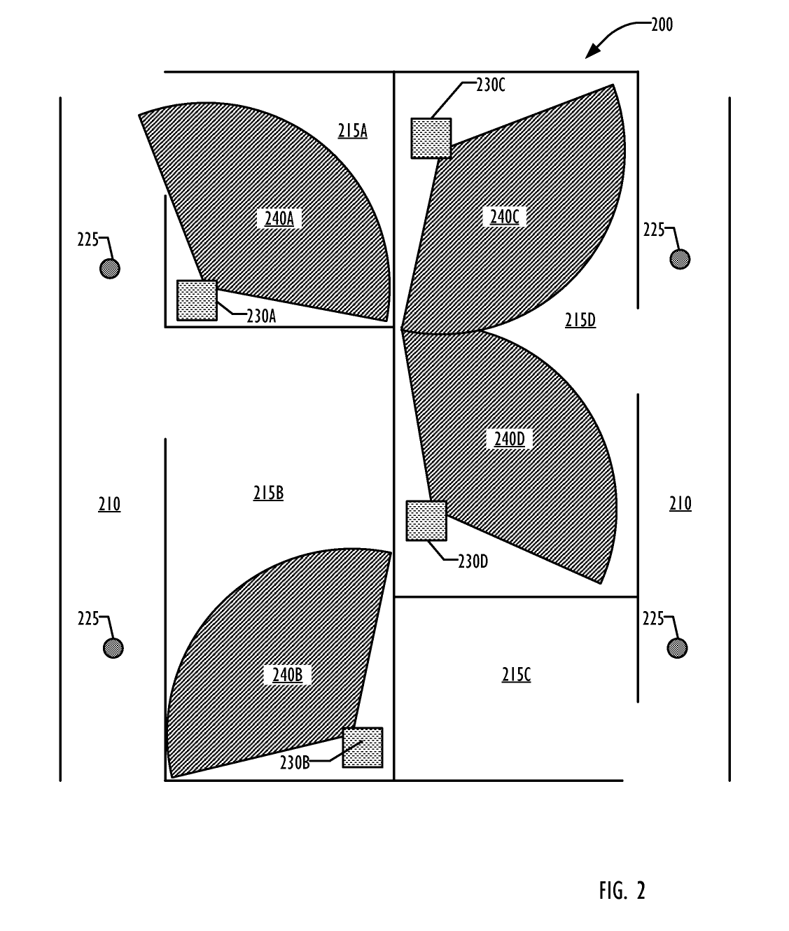

FIG. 2 illustrates views provided by cameras within the desktop videophones 230 forming part of a surveillance network within an office environment 200, according to an embodiment of the invention. The surveillance network includes desktop videophones 230A-230D and surveillance cameras 225, according to an embodiment. Office environment 200 includes offices 215A-215D and hallways 210. Surveillance cameras 225 are located within hallways 210, providing surveillance monitoring of open, high traffic spaces. However, the view of surveillance cameras 225 is limited, or obstructed, by the walls defining hallways 210 and offices 215. That is, surveillance cameras 225 have a limited ability to monitor areas within offices 215.

As shown in FIG. 2, each office 215A, 215B and 215D includes at least one desktop videophone 230 including a camera. The approximate view 240 of each respective camera in desktop videophones 230A-230D is illustrated. For example, view 240A defines a view of a camera that is associated with desktop videophone 230A that can be had by orienting the camera at a particular position. For example, the camera in videophone 230A may be oriented by selectively moving the camera using its pan and tilt controls to provide view 240A. Using pan and tilt controls enable a majority of office 215A to be monitored. Office 215A includes a single desktop videophone 230A, which due to the orientation and range of the camera has a view 240A by which it may monitor a majority of office 215A, according to an embodiment. Similarly, desktop videophone 230B has a range and orientation through pan and tilt control such that a larger portion of office 215B is within view 240B. There is no desktop videophone or surveillance camera within office 215C, and as such, office 215C is unmonitored by the surveillance network. However, each view 240 may be defined by the range of the desktop speakerphone's camera. As such, a variety of ranges and focal lengths are possible. In addition, as depicted for videophone 230B, the view 240B may be defined by the walls or partitions enclosing the cubicle or office 215B in which the desktop videophone 230B is located. It is to be understood that in many cases, the view 240 is defined by a combination of these things.

A single office or cubicle may have more than one desktop videophone, as illustrated in office 215D. Office 215D includes two desktop videophones 230C and 230D, having views 240C and 240D, respectively, which together monitor a majority of office 215D. In an embodiment, each of videophones 230C and 230D corresponds to a separate workspace and can provide a view of the respective workspace. Each videophone 230C-230D may provide different and/or complementary views of the space defined by walls or partitions. In another embodiment, the views of one desktop videophone, for example, desktop videophone 230C may overlap views of a second desktop videophone 230D through an increase in the range of view for each camera associated with the respective desktop videophone 230C-230D. In an embodiment, views of desktop videophones 240C-240D may include static overlapping views of walls, desktop or, alternatively, views may include dynamic views as each desktop videophone 240C-240D may be panned and tilted.

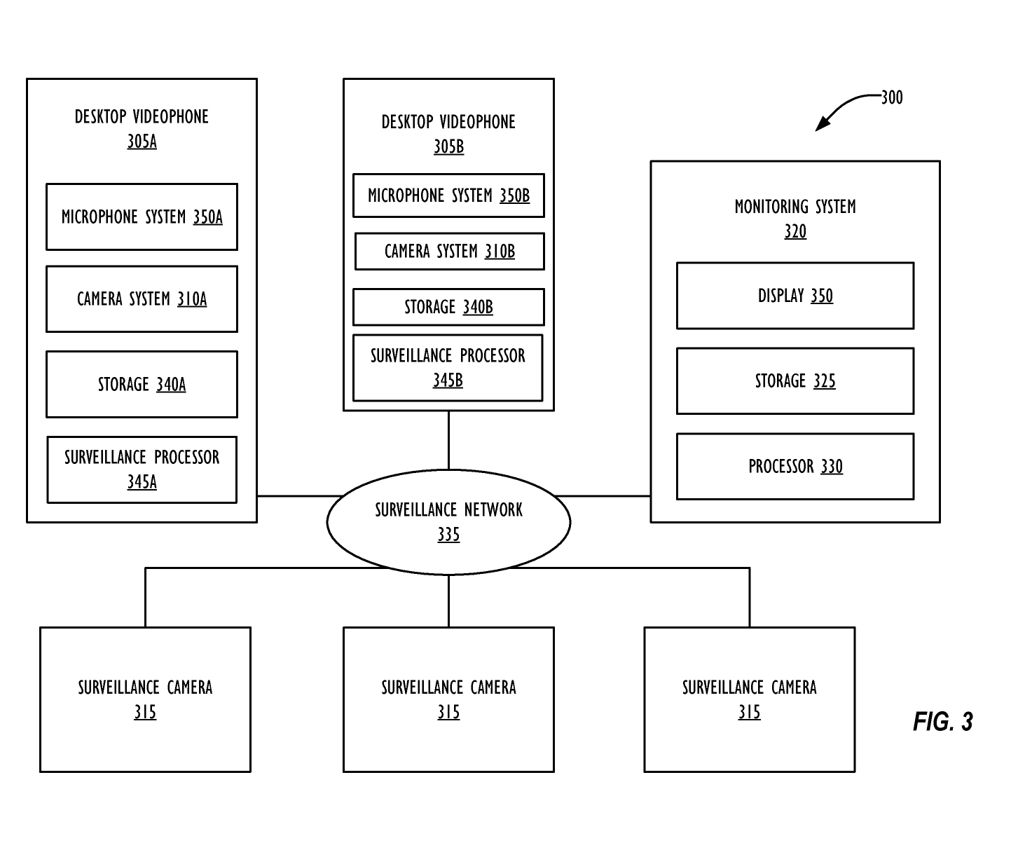

FIG. 3 illustrates a system diagram of a surveillance system 300 including desktop videophones 305, according to an embodiment. In addition to videophones 305, surveillance system 300 includes surveillance cameras 315 and at least one monitoring system 320. Videophones 305, surveillance cameras 315, and monitoring system 320 communicate via a network 335. Videophones 305 may be substantially similar to the videophones 230 shown and described in FIG. 2.

Surveillance cameras 315 each generate image data representative of the scene within view, according to an embodiment. For example, in an office context, surveillance cameras may monitor open areas, such as entry doors, lobbies, and hallways. Surveillance cameras 315 may continuously generate and transmit image data, or at least one of the generation and transmission may be limited by either local or remote controls. At least a portion of the image data generated by a surveillance camera 315 is transmitted to monitoring system 320. Monitoring system 320, described in detail below, may control the generation and transmission of image data by surveillance cameras 315, in addition to storing and analyzing image data. For example, monitoring system 320 may activate surveillance cameras 315 during one or more defined time intervals. The defined time intervals may include non-work hours, hours during which the facility is closed, or hours when an out of office or away from desk videophone designation is active. Alternatively, or in addition to activation of monitoring system 320 during a defined time interval, motion detection software within the surveillance camera may result in generation of image data and/or transmission of image data when motion is detected. In another embodiment, monitoring system 320 may be configured to discard image data when adjacent videophones and/or monitoring system 320 indicates a false alarm for the presence of an intruder or motion detection was erroneous that cause image data to be generated in error.

In a conferencing mode such as, for example, during business hours, each desktop videophone 305 may be used by a near-end user to communicate with one or more far-end users. Each desktop videophone 305 may be a PSTN, VoIP, video phone, etc. Examples of videophone 305 can include products such as POLYCOM® VVX® series, etc. Desktop videophones 305 include a variety of components related to end-to-end communication that are not illustrated in order to not distract from the role of the videophone 305 within a surveillance network.

Each desktop videophone 305 may also be used within the surveillance network 335. Each desktop videophone 305 may include a camera system 310. Each camera system 310 may include a camera for generating image data, according to an embodiment. In an embodiment, each desktop videophone 305 may be configured where each camera may be mounted remotely from the videophone 305 so as to capture image data further away from the desktop. The image data is reflective of the scene within view of camera system 310. As the camera system 310 may be selectively panned and tilted, the scene within view of the camera system 310 that is captured may change based on the orientation of the lens in the camera system 310. In an embodiment, the camera may include infrared night vision for capturing infrared images within a dark environment or at night. In an embodiment, each camera system 310 can include an infrared illuminator for projecting infrared light onto a scene for illumination when there is no external source of light to illuminate the scene within view of the camera system 310. Captured image data for camera system 310 may include one or more still images or a continuous video of the scene within view of the camera system 310. In an embodiment, the image data may include audio content in addition to visual content. Image data may be used for desktop surveillance of a cubicle or office or for video-based communication, via transmission from a near end user to one or more far-end users. Image data may be processed on desktop videophone 305 prior to transmission to monitoring system 320. In another embodiment, camera system 310 may provide image data to monitoring system 320 as part of surveillance system 300. As such, desktop videophone 305 may have a ‘communication mode’ setting, indicating that the camera system is engaged in generating image data for communication to a far-end user, and a ‘surveillance mode’ setting, indicating that the camera system is engaged in generating image data for surveillance purposes.

The placement of desktop videophones 305 at workspaces within enclosed or partially-enclosed rooms, offices, or cubes allows surveillance system 300 to visually monitor workspaces that are obstructed from the view of surveillance cameras 315, for example by walls or partitions. By using existing camera systems 310 in the desktop videophones 305, additional surveillance cameras 315 are not required in order to monitor areas within view of a desktop videophone 305.

Image data from desktop videophones 305 may be stored and/or analyzed as part of surveillance operations. In an embodiment, image data is analyzed and/or stored locally, on desktop videophone 305 and can include image enhancement, for example, low light contrast enhancement through histogram equalization and low-frame rate with a high resolution mode processing. In yet another embodiment, image data analysis and/or storage is performed across both the desktop videophone 305 and monitoring system 320.

For example, desktop videophone 305A includes storage 340 for storing image data, according to an embodiment of the invention. Local storage 340 may assist in regulating the flow of data to the monitoring system 320 by allowing transmission at a specified time or upon demand from the monitoring system 320, which may reduce the network bandwidth required to transmit surveillance-related image data from a number of cameras to the monitoring system 320. Storage 340 may be a memory dedicated to storage of surveillance-related image data, or a general storage medium storing image data along with other data relevant to desktop videophone 305, such as user settings.

Desktop videophone 305A includes a surveillance processor 345, according to an embodiment of the invention. Surveillance processor 345 may direct the acquisition or analysis of image data. For example, surveillance processor 345 may direct the camera system 310 to acquire image data during one or more specified time intervals. Alternatively, surveillance processor 345 may perform motion detection with respect to image data captured by camera system 310. This may allow, for example, storage or transmission of image data only when motion is detected within the view of camera 310, and discarding of image data where no motion is detected. Other more sophisticated analytics and processing may be performed, such as facial recognition. By performing analysis locally to the desktop videophone 305, image data may be eliminated prior to transmission to monitoring system 320, reducing bandwidth requirements for network 335. In one embodiment, surveillance processor 345 is a processor dedicated to surveillance functions. In yet another embodiment, surveillance controls and analysis may be performed by a multi-purpose processor within desktop videophone 305.

In another embodiment, monitoring system 320 may identify overlapping areas of coverage and/or automatically activate other videophones during monitoring, according to an embodiment. In one embodiment, all desktop videophones may be continuously recording and sending audio and video to storage 325. In another embodiment, monitoring system 320 may activate videophones in various directions, for example activate from a sleep mode, if activity, noise, or the like is detected. To illustrate, surveillance system 300 may use desktop videophone 305A to capture images and/or sound when motion is detected within the view of camera system 310A such as, for example, when motion is detected within the vicinity of desktop videophone 305A or when sounds/voices are detected by microphone system 350A, indicating the presence of a person within the vicinity of desktop videophone 305A. Subsequently, other desktop videophones may be activated to capture audio and video in various directions within the monitored area. Therefore, as the intruder moves away from desktop videophone 305A, surveillance system 300 may continuously perform image capture and/or audio capture for audio or motion from other desktop videophones 305. In another embodiment, surveillance system 300 may also detect loss of power/failure of some videophones and may activate other functioning desktop videophones to perform image capture from other nearby working desktop videophones.

In another embodiment, storage or analytics are performed remotely from desktop videophone 305. For example, desktop videophone 305B does not include dedicated surveillance storage or surveillance processors, but rather transmits image data related to surveillance to monitoring system 320 for storage, analysis, and/or processing.

In an embodiment, desktop videophones 305 may be remotely activated in a surveillance capacity. For example, a network interface, either via monitoring system 320 or coupled to surveillance network 335, may enable remote access to desktop videophone 305. Alternatively, a surveillance mode may be activated remotely by a user calling in to the desktop videophone via the communication network to access and change the videophone's settings.

Monitoring system 320 receives image data from each desktop videophone 305 and surveillance camera 315, according to an embodiment. In an embodiment, monitoring system 320 enables viewing, storage, analysis, and/or processing of image data. Monitoring system 320 includes a display 350, storage 325, and a processor 330, according to an embodiment. Display 350 enables viewing of image data generated by desktop videophones 305 and surveillance cameras 315. Display 350 may enable a user to monitor image data in real time or review previously recorded data stored in storage 325. In addition, display 350 may be a virtual display presented in a web-based graphical user interface (GUI), allowing access and viewing on an internet-enabled device. Storage 325 stores image data. Processor 330 may control or send instructions to desktop videophones 305 and surveillance cameras 315, and/or may perform analytics on or otherwise process image data related to surveillance.

Monitoring system 320 may be local device on the surveillance network, a virtual system, or a combination of both. For example, monitoring system may be a single device coupled to the surveillance network 300. Monitoring system 320 may be centralized or distributed. Alternatively, elements of monitoring system 320 may be cloud-based, such as storage 325 and processor 330. Monitoring system 320 may include a network interface to a wide area network (WAN) to enable cloud-based and virtual aspects.

Referring back to FIG. 3, desktop videophones 305, surveillance cameras 315, and monitoring system 320 are communicatively coupled via surveillance network 335, according to an embodiment of the invention. In an embodiment, surveillance network 335 is the same network used by desktop videophones 305 to transmit audio and video-based communications. In another embodiment, the surveillance network 335 used to transmit surveillance-related image data is separate from the network used to transmit communications-related data. Surveillance network 335 may be wired, wireless, or a combination of both wired and wireless connections. Surveillance network 335 may be, for example, a local area network (LAN).

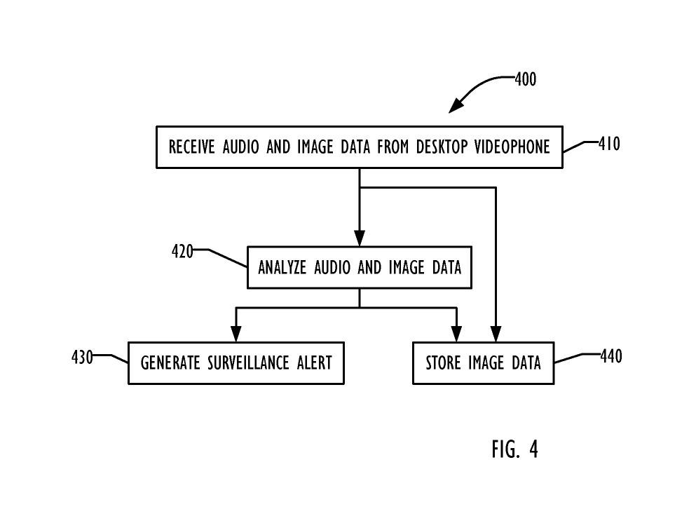

FIG. 4 illustrates a method 400 for processing surveillance image data received from a desktop videophone, according to an embodiment of the invention. Method 400 may be executed by one or more processors within a desktop videophone, by one or more processors within a monitoring system, or by a combination of videophone and monitoring system-based processors. In block 410, image data is received from a desktop videophone, according to an embodiment. In an embodiment, image data may be received in response to detecting motion or other security concern around the desktop videophone. In an embodiment, the image data is then stored, as shown in block 440. The image data may be stored in storage within a desktop videophone, in storage within monitoring system, or in a combination of videophone and monitoring system-based storage.

In another embodiment, the image data is analyzed, as shown in block 420. Analysis may relate to a variety of surveillance purposes, for example, motion detection, facial recognition, pattern recognition, object sizing, tracking, and/or counting, optical character recognition (OCR), etc. In an embodiment, image data may be analyzed on the desktop videophone prior to transmission of the image data to the monitoring system. Based on the results of the analysis in bock 420, a surveillance alert may be generated as shown in block 430. The alert may be used, for example, to indicate to a user that activity of interest has been detected at a workspace under surveillance. In addition, image data may be stored based on the results of image data analysis 420, as shown in block 440. For example, image analysis 420 may involve motion detection, and only portions of image data that have been identified as including motion may be stored as shown in block 440.

A surveillance system incorporating multiple desktop videophone devices has been disclosed. Each desktop videophone enables surveillance monitoring of an area within view of the videophone camera. An office environment having a number of desktop videophones may, as such, expand the reach of an existing office-wide surveillance network without procuring and installing additional surveillance cameras to cover areas within view of a desktop videophone.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein. For Example, though embodiments are described with respect to desktop videophones, it is to be understood that any communication device including a camera and a network interface may be suitable for incorporation into a surveillance network. For example, table-top conferencing systems, (large-scale) video conferencing equipment in conference rooms, laptops with cameras, desktops with webcams, etc. may be used as part of a surveillance network. In addition, use of mobile devices, such as phones and tablets, that are located within an office space (for example, when on a wireless LAN associated with an office space) as part of a surveillance network is within the scope of this disclosure. Furthermore, though the foregoing discussion is primarily within a general office context, aspects of the invention are applicable within any context in which videophones may be used, for example, by call centers, homes, schools, or health care providers.

What is claimed is:

1. A desktop surveillance system, comprising:
a plurality of desktop videophones within an office environment, wherein each desktop videophone includes:
at least one processor;
a camera system coupled to the at least one processor and configured to generate image data;
a microphone system coupled to the at least one processor and configured to generate audio data; and
a storage device coupled to the at least one processor and storing instructions that when executed by the at least one processor causes the desktop videophone to generate the image data and the audio data;
wherein the desktop videophone is configured to send at least the image data to a monitoring system.

2. The desktop surveillance system of claim 1, wherein the instructions further comprise instructions that when executed by the at least one processor causes each of the desktop videophones to generate the image data when motion is detected in the vicinity of each of the desktop videophones.

3. The desktop surveillance system of claim 1, wherein the instructions further comprise instructions that when executed by the at least one processor cause each of the desktop videophones to generate the audio data when one or more of a voice or a sound is detected in the vicinity of each of the desktop videophones.

4. The desktop surveillance system of claim 1, wherein the instructions further comprise instructions that when executed by the at least one processor cause each of the desktop videophones to enhance the image data prior to transmitting the image data to the monitoring system.

5. The desktop surveillance system of claim 4, wherein the instructions to enhance the image data includes instructions to perform one or more of low light contrast enhancement through histogram equalization or low-frame rate with a high resolution mode processing.

6. The desktop surveillance system of claim 1, wherein the camera system includes a pan, tilt and zoom (PTZ) camera system.

7. The desktop surveillance system of claim 1, wherein the desktop videophone includes an infrared (IR) detector.

8. The desktop surveillance system of claim 1, wherein the desktop videophone includes an IR illuminator with an IR detector.

9. The desktop surveillance system of claim 1, wherein the instructions further comprises instructions to cause the at least one processor to store the image data in the storage device when motion is detected.

10. The desktop surveillance system of claim 1, wherein each of the desktop videophones further comprises a display for displaying the image data.

11. The desktop surveillance system of claim 1, wherein the image data includes one or more still images.

12. The desktop surveillance system of claim 1, wherein the image data includes video data.

13. A surveillance system, comprising:
a plurality of desktop videophones, wherein each desktop videophone includes:
a videophone processor;
a camera system coupled to the videophone processor and configured to generate image data;
a microphone system coupled to the videophone processor and configured to generate audio data; and
a videophone storage device coupled to the videophone processor and storing instructions that when executed by the videophone processor cause the desktop videophone to generate the image data and the audio data; wherein the desktop videophone is configured to send at least the image data to a monitoring system; and
the monitoring system communicatively coupled to the plurality of desktop videophones, wherein the monitoring system comprises:
at least one second processor;
a second storage device coupled to the at least one second processor and including second instructions; and
a surveillance storage device coupled to the at least one second processor and configured to store received image data and audio data,
wherein the second instructions when executed by the at least one second processor cause the monitoring system to store at least the image data from the desktop videophone on the surveillance storage device.

14. The surveillance system of claim 13, wherein the instructions further comprise instructions that when executed by the videophone processor cause the desktop videophone to generate the image data when motion is detected in the vicinity of the desktop videophone.

15. The surveillance system of claim 13, wherein the instructions further comprise instructions that when executed by the videophone processor cause the desktop videophone to generate the audio data when one or more of voice or sound is detected in the vicinity of the desktop videophone.

16. The surveillance system of claim 13, wherein the instructions further comprise instructions that when executed by the videophone processor cause the desktop videophone to enhance the image data prior to communicating the image data to the monitoring system.

17. The surveillance system of claim 16, wherein the instructions to enhance the image data includes instructions that when executed by the videophone processor cause the desktop videophone to perform low light contrast enhancement through histogram equalization or low-frame rate with a high resolution mode processing.

18. The surveillance system of claim 13, wherein the camera system includes a pan, tilt and zoom (PTZ) camera system.

19. The surveillance system of claim 13, wherein the camera system includes an infrared (IR) detector.

20. The surveillance system of claim 13, wherein the camera system includes an IR illuminator with an IR detector.

21. The surveillance system of claim 13, wherein the second instructions further comprise instructions that when executed by the at least one second processor cause views of a first camera system associated with a first desktop videophone to overlap views of a second camera system associated with a second desktop videophone, wherein the first and second desktop videophones are inclusive of the plurality of desktop videophones.

22. The surveillance system of claim 13, wherein the second instructions further comprise instructions that when executed by the at least one second processor cause the monitoring system to activate one or more other desktop videophones responsive to detecting a change in environmental cues in the vicinity of a first desktop videophone.

23. The surveillance system of claim 13, wherein the second instructions further comprise instructions to cause the at least one second processor to analyze the image data.

24. The surveillance system of claim 13, wherein the instructions further comprises instructions that when executed by the videophone processor cause the videophone processor to store the image data in the videophone storage device when motion is detected.

25. The surveillance system of claim 13, wherein the monitoring system further comprises a display for displaying the image data.

26. The surveillance system of claim 25, wherein the second instructions further comprises instructions that when executed cause the at least one second processor to display the image data from one or more of the plurality of desktop videophones on the display.

27. The surveillance system of claim 25, wherein the image data is displayed in real time.

28. The surveillance system of claim 13, wherein the image data includes one or more still images.

29. The surveillance system of claim 13, wherein the image data includes video data.
